(19) United States
(12) Patent Application Publication
(10) Pub. No.: US 2015/0278768 A1
(43) Pub. Date: Oct. 1, 2015

(54) Interviewing Aid

(71) Applicants: John Weldon Boring, Scotts Valley, CA (US); Carol Marie Malady, Scotts Valley, CA (US)

(72) Inventors: John Weldon Boring, Scotts Valley, CA (US); Carol Marie Malady, Scotts Valley, CA (US)

(21) Appl. No.: 14/676,674

(22) Filed: Apr. 1, 2015

Related U.S. Application Data
(60) Provisional application No. 61/973,526, filed on Apr. 1, 2014.

(51) Int. Cl. G06Q 10/10; G06F 3/0482; G06F 3/0484; G06F 17/30

(52) U.S. Cl. CPC G06Q 10/1053; G06F 17/30876; G06F 3/0482; G06F 3/04842

(57) ABSTRACT

A system includes a network-connected server, a computer processor operating in the server, a data repository coupled to the server, a computerized appliance connected to the network, executing a browser program, and operable by an interviewer, coded instructions executing on the processor, information regarding a job to be filled stored in the data repository, the information comprising skills required for the job and preprogrammed questions associated with each skill required for the job, and information regarding a candidate for the job to be filled stored in the data repository. The instructions provide for distributing the one or more questions associated with each skill to the user acting as the interviewer, enabling the user to ask the questions of the candidate present with the interviewer and to record the candidate's responses.

### CROSS-REFERENCE TO RELATED DOCUMENTS

The instant case claims priority to Provisional Patent Application 61/973,526, filed on Apr. 1, 2014, and all of the disclosure of the prior case is incorporated herein at least by reference.

### BACKGROUND OF THE INVENTION

1. Field of the Invention

The present invention is in the field of enterprise networking and communications and pertains particularly to methods and apparatus for staging and conducting interviews.

2. Discussion of the State of the Art

It is well known in the art that commercial enterprises that employ persons in various positions have a great deal of time and money invested in interviewing and evaluating candidates for positions that have to be filled. Not every case is alike, because job requirements for just about every position will differ. This means that the questions an interviewer might want (or need) to ask will be different in different cases, and evaluation may differ as well.

What is clearly needed in the art is a cloud-based solution that enables enterprises and interviewers to create personalized interview procedures for different positions, to define new positions, to configure the system to fit each enterprise, and to aid in conducting and evaluating interviews.

### BRIEF SUMMARY OF THE INVENTION

A system is provided comprising a network-connected server, a physical computer processor operating in the network-connected server, a data repository coupled to the network-connected server, a first computerized appliance connected to the network and operable by a user acting as an interviewer, coded instructions executing on the physical processor, information regarding a job to be filled stored in the data repository, the information comprising skills required for the job and one or more questions associated with each skill required for the job, and information regarding a candidate for the job to be filled stored in the data repository. The coded instructions provide for distributing the one or more questions associated with each skill to the user acting as the interviewer, enabling the user to ask the questions of the candidate present with the interviewer and to record the candidate's responses.

In one embodiment the coded instructions provide an interactive Interviewer Dashboard on a display of the computerized appliance, the Interviewer Dashboard providing one or more interactive interfaces enabling the interviewer to access the information regarding the job to be filled and the candidate for the job, to access the preprogrammed questions for each skill, to ask the questions of the candidate present with the interviewer and to record the candidate's responses.

In one embodiment there are multiple jobs to be filled with information stored in the data repository, one or more candidates for each job to be filled, skills associated with each job, and preprogrammed questions associated with each skill, and wherein the Interviewer dashboard enables the interviewer to select jobs, candidates and questions to perform interviews for individual ones of the jobs to be filled with individual ones of the candidates for each of the jobs. Also in one embodiment the system further comprises a second computerized appliance connected to the network and operable by the candidate for the job, and wherein the candidate for the job connects to the network-connected server and is provided with a Candidate Interface, and the interviewer is enabled to question the candidate remotely, with the candidate's responses recorded in the data repository for later retrieval and analysis.

In one embodiment the coded instructions enable entry of new jobs to be filled with job descriptions, new skill sets associated with the jobs to be filled, and new question sets associated with the skill sets. Also in one embodiment the interviewer is enabled to edit skills and question sets after selecting a job to be filled and a candidate for the job, and before or during the interview with the candidate. In one embodiment there is a Question Builder function wherein interview questions are created having three parts, a first part being an opening phrase, a second part being a problem or issue, and a third part being a difficulty clause, and wherein the parts of questions may be randomly shuffled to create new questions. And in one embodiment the Interviewer Dashboard enables the interviewer to retrieve stored candidate responses associated information, and to select a best candidate for the job to be filled.

In another aspect of the invention a method is provided, comprising presenting an interactive interface for a user acting as an interviewer on a display of a computerized appliance connected on a network to a network-connected server executing coded instructions on a physical computer processor, distributing to the user acting as an interviewer questions stored in a data repository coupled to the server, the questions specifically associated with skills required for a job to be filled, asking by the user acting as an interviewer of a candidate for the job to be filled, the candidate present with the interviewer, the questions associated with each skill, and recording the candidate's responses to each question for later analysis.

In one embodiment the user acting as an interviewer is presented with an interactive Interviewer Dashboard enabling the user to access information regarding the job to be filled, the candidate for the job, information comprising the skills required for the job and the questions associated with each skill directly from the data repository.

In one embodiment the method further comprises a second computerized appliance connected to the network and operable by the candidate for the job, and wherein the candidate for the job connects to the network-connected server and is provided with a Candidate Interface, and the interviewer is enabled to question the candidate remotely, with the candidate's responses recorded in the data repository for later retrieval and analysis. In one embodiment the coded instructions enable entry of new jobs to be filled with job descriptions, new skill sets associated with the jobs to be filled, and new question sets associated with the skill sets. Also in one embodiment the interviewer is enabled to edit skills and question sets after selecting a job to be filled and a candidate for the job, and before or during the interview with the candidate.

Still in one embodiment the method comprises a Question Builder function wherein candidate questions are created having three parts, a first part being an opening phrase, a second part being a problem or issue, and a third part being a difficulty clause, and wherein the parts of questions may be randomly shuffled to create new questions. In one embodiment the Interviewer Dashboard enables the interviewer to retrieve stored candidate responses associated information, and to select a best candidate for the job to be filled. In one embodiment the Interviewer Dashboard enables the interviewer to retrieve stored candidate responses associated information, and to select a best candidate for the job to be filled. And in one embodiment the interactive Interviewer Dashboard enables the interviewer to assess the candidate's likelihood for success in the position, for storage in the data repository.

### BRIEF DESCRIPTION OF THE SEVERAL VIEWS OF THE DRAWINGS

FIG. 1 is an architectural overview of a job interview network according to an embodiment of the present invention.

FIG. 2 is an exemplary screen shot of an interview management dashboard depicting a search function to find available job positions.

FIG. 3 is a process flow chart depicting steps for searching existing and adding new jobs to the job interview network.

FIG. 4 is an exemplary screen shot of the interview management dashboard depicting selection of a job position for interviewing candidates.

FIG. 5 is a process flow chart depicting steps for selecting interview questions and searching for job candidates for a selected position.

FIG. 6 is an exemplary screen shot of the interview management dashboard depicting selection of skills for a job position and interview questions for a pending interview.

FIG. 7 is a process flow chart depicting steps for selecting skills and accessing relevant questions to add to the interview.

FIG. 8 is an exemplary screen shot of the interview management dashboard depicting addition of new skills for a position and a question builder interface for building new questions according to an embodiment of the present invention.

FIG. 9 is a process flow chart depicting steps for adding new skills to a skills database according to an embodiment of the invention.

FIG. 10 is a process flow chart depicting steps for building a question for a job interview skill

FIG. 11 is an exemplary screen shot of the question builder interface and recommendations of certain subject areas to avoid when selecting or building new questions.

FIG. 12 is an exemplary screen shot of the interview management dashboard depicting gathering of interview question/skill sets for distribution to an interviewer, the distributed data including data about a candidate to be interviewed.

FIG. 13 is a process flow chart depicting steps for adding job candidates to a position interview event according to an embodiment of the invention.

FIG. 14 is a process flow chart depicting steps for assigning a job candidate to an interviewer and transferring data to the interviewer before the interview date.

FIG. 15 is an exemplary screen shot of the interview management dashboard displaying an interview assistant for an interview team member.

FIG. 16 is a process flow chart for conducting an interview according to an embodiment of the present invention.

FIG. 17 is an exemplary screen shot of an interview assessment interface according to an embodiment of the present invention.

FIG. 18 is a process flow chart depicting steps for rating a candidate's skill levels after an interview according to an embodiment of the present invention.

FIG. 19 is an exemplary screen shot of the interview assessment interface depicting a utility for final rating of a candidate according to an embodiment of the present invention.

FIG. 20 is a process flow chart depicting steps for final rating of a job candidate according to an embodiment of the present invention.

FIG. 21 is an exemplary interactive screen illustrating a statistical analysis and reporting function provided in an embodiment of the invention.

### DETAILED DESCRIPTION OF THE INVENTION

In various embodiments described in enabling detail herein, the inventor provides a unique system for managing a job interview and assessment process over a network. The present invention is described using the following examples, which may describe more than one relevant embodiment falling within the scope of the invention.

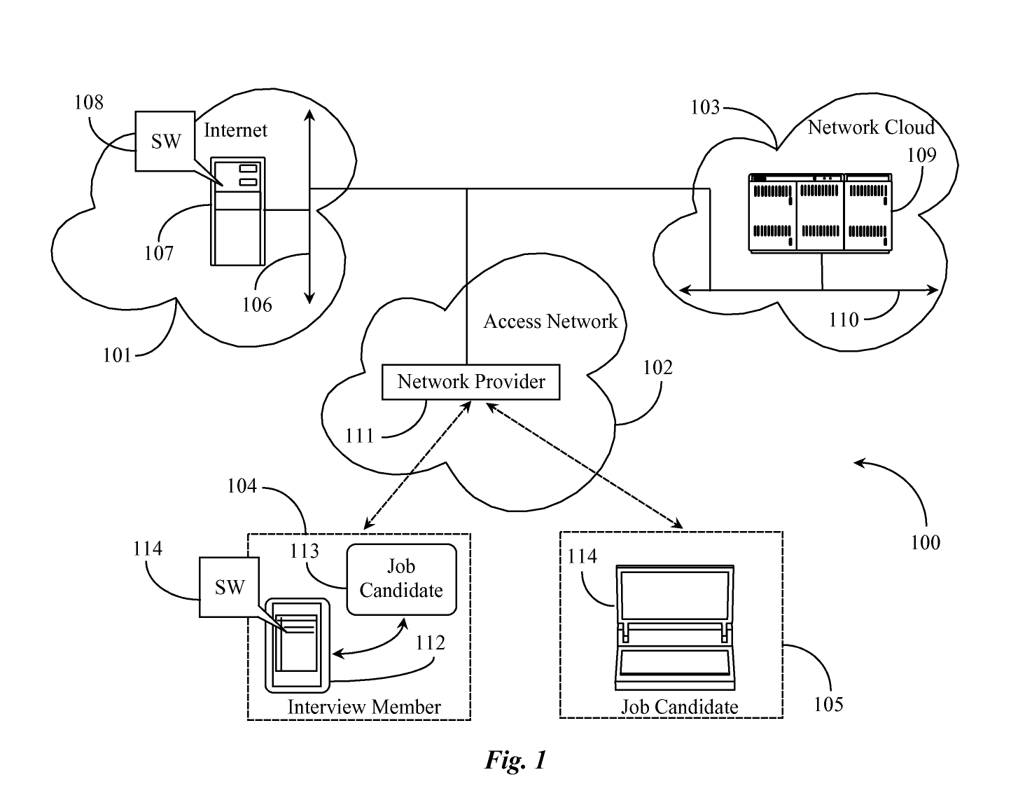

FIG. 1 is an architectural overview of a job interview network 100 according to an embodiment of the present invention. Network 100 includes the well-known Internet network 101. Internet 101 is also represented herein by a network backbone 106. Network backbone 106 represents all of the lines, equipment, and access points that make up the Internet network as a whole. Therefore, there are no geographic limitations to practicing the present invention. It is noted herein that network 101 may be a corporate wide area network (WAN) instead of an Internet network without departing from the spirit and scope of the present invention.

Network backbone 106 supports a network server 107. Server 107 may be a multimedia application server hosted by a third party service provider. A third-party provider may offer job interview training and functionality to various enterprises and may handle the data processing and serving for those enterprises.

In one embodiment server 107 is an enterprise server hosted by an enterprise that has acquired job interview functionality through a software (SW) application 108 executable on server 107. In one embodiment server 107 is a Web server and the functionality of SW 108 is accessed through server 107 from any network capable device that supports a network browser. In this embodiment there may be additional servers not illustrated such as an application server hosting software 106 and connected to server 107. Also in this embodiment access to functionality may be through a web service that brokers the functionality.

Job interview network 100 includes a cloud data processing and storage network 103. Network 103 is further illustrated by a network backbone 110 representing all of the lines, equipment and access points making up the network computing cloud accessible to practitioners of the present invention. Data storage and processing facility 109 represents all of the computing equipment in the cloud network assigned to deliver the functionality of the present invention.

Network 100 includes an access network 102. Access network 102 may be a wireless cellular data network through which a network service provider such as provider 111 may provide access to Internet 101 to users operating wireless network appliances such as android devices, notebook computers, and the like.

Software 108 includes a graphic browser-based user interface that may be served to an accessing user, such as a job interviewer, that is a member of the service supported by the present invention, such as interview member 104 operating a mobile device 112 to access and practice the present invention. Interview member 104 may be an employee of an enterprise that has acquired the functionality of the present invention by registering for a provided service or by purchasing the software and setting up its own job interview placement network.

Device 112 has a software application 114 executable therefrom. SW 114 may be a graphics user interface downloaded to device 112 from server 107 in order to practice the invention and gain network access. In one embodiment the user interface is server executed and accessed through an application program interface (SW 114). In another embodiment SW 114 may be a standalone application that may be operated off line and subsequently may be synced with application 108 running on server 107.

Interview member 104 operating device 112 in this example is engaged in a process of interviewing a job candidate 113. In this embodiment candidate 113 is in the physical presence of the interviewer and is being interviewed by interviewer member 104 with real time assistance via SW 114 running on device 112. In another example a job candidate such as job candidate 105 may operate a laptop computing device 114, and may be interviewed remotely by interview member 104 with the aid of SW 114 running on device 112. In this case the job candidate may be online and responding to interview questions via laptop 114 while interview member 104 uses device 112 to conduct the interview. In such a circumstance server 107 may function as the host server of the interview, which may be conducted in any communications media, for example voice and video, or text chat.

Job interview member 104 may be recruited from an enterprise employee pool to conduct job interviews. In one embodiment interview member 104 is a trained interviewer working for the enterprise. In another embodiment interview member 104 is a third-party affiliated individual that may conduct interviews for positions available across multiple enterprises or businesses.

In all circumstances, SW 114 enables the interview member to conduct the interview with direct support relative to questions to be asked in the interview and how the candidates' responses may be interpreted. It is important to note herein that other individuals in an organization or group practicing the invention may be involved in behind-the-scene tasks such as recruiting job candidates, scheduling interviews, adding job positions, and so on.

In applications of the invention in various embodiments a job interview member such as member 104 may conduct a job interview with a candidate live or remotely with the assistance of SW 114. SW 114 guides the interviewer through the entire job interview process from the beginning to the end including rating or qualifying the candidate during the interview process or after the interview process. Other important features of SW 114 and SW 108 are described further below in this specification.

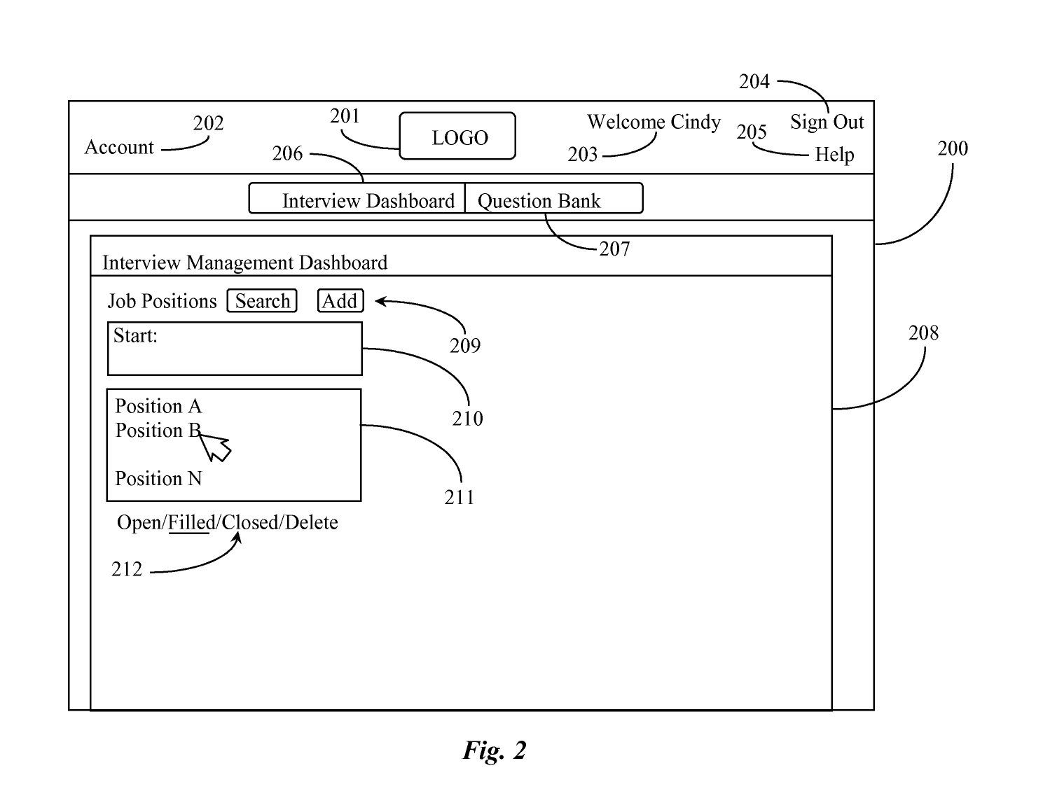

FIG. 2 is an exemplary screen shot of an interview management dashboard 200 depicting a search function to find available job positions. Dashboard 200 is a browser-based interface that may be accessed from a server such as server 107 aided by SW 108 and displayed on a remote device such as on device 112 as SW 114. Dashboard 200 may include a company logo 201 representing the enterprise using the SW or a third-party logo of a third party offering the service of the present invention. In one embodiment the interface is customized for the client enterprise relative to design and functionality.

Dashboard 200 displays a link 202 to a user account. In this case the account belongs to a user “Cindy” (203) who may be an interview member analogous to interview member 104 of FIG. 1. A message welcoming the user, in this case Cindy, is displayed while the user is signed in and a link 204 for signing out is also provided. In order to display the interview management dashboard the user clicks on link 206. The dashboard displays as page 208. A link 207 is provided to a question bank database not illustrated here.

In this example a user Cindy is signed in and is searching for current job positions already in the system or may add one or more job positions into the database. In one embodiment Cindy is an enterprise manager or a job recruiter and is charged with the task of finding jobs that need to be filled and with adding new jobs when they become available for hiring.

Page 208 includes search and add functions 209 and a text input or dialogue box 210 adapted to accept search criteria. In one embodiment a browse function may be added to enable browsing of existing positions without adding any search terms. A search results window 211 is provided to list the search results in display for the user. Positions A through N are displayed in window 211, which may be scrollable.

The user may select from returned results A through N by mouseover or by clicking a listed position with an input device (arrow) in order to determine current status 212 of a returned job position. In this example the user has selected position B resulting in display of position status 212. In this example the job position B is currently filled. A delete option may also be provided in the status menu to enable purging of obsolete or otherwise expired job positions that are no longer available.

The interview dashboard may provide access to multiple functions not depicted here, such as changing status of existing jobs to open, filled, or closed. Other functions besides adding new positions include finding and adding job candidates for later interview, building new questions for job interview skill definitions, adding new skills for a job position, assigning questions to a job interview and assigning interview team members to interview certain candidates. These and other functions of the present invention are further described below.

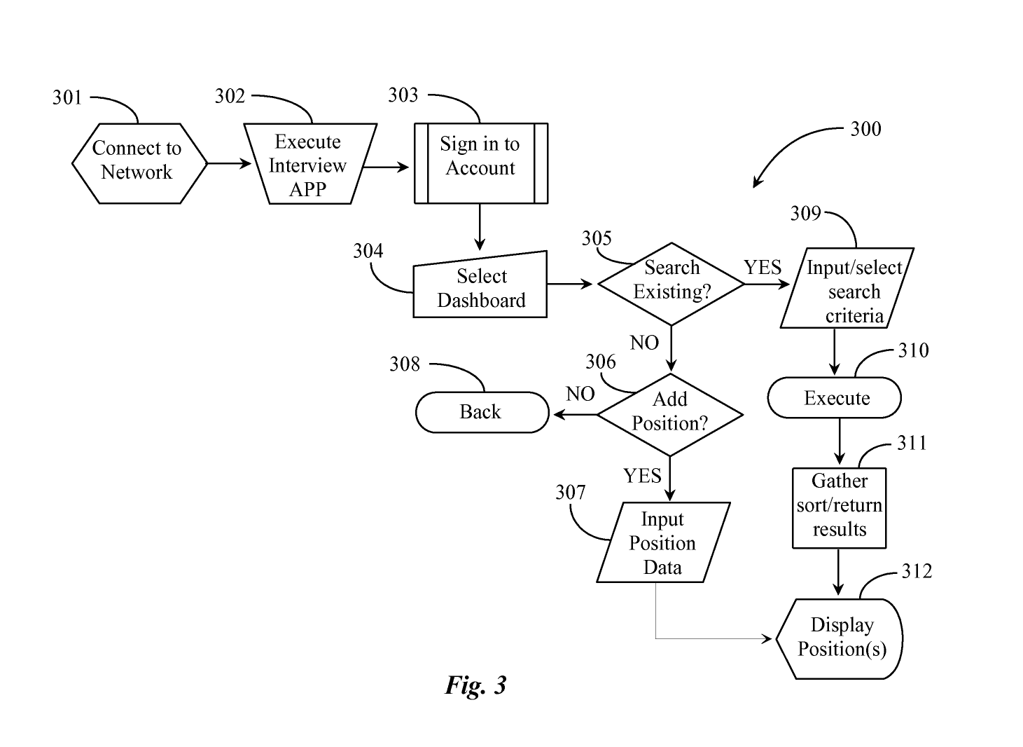

FIG. 3 is a process flow chart 300 depicting steps for searching existing and adding new jobs to the job interview network. In step 301 a user such as one operating device 112 of FIG. 1 connects to the Network. It is important to note herein that the network may or may not be the internet network. At step 302 the user may execute the interview application supported on the accessing device. In one embodiment the user navigates to a specific server hosting the application and must authenticate with the server in order to access the application. In this example the user has the application on the accessing device and may sign in to the service at step 303.

The user may navigate to the interview dashboard screen at step 304. At step 305 the user may decide whether or not to search for existing jobs already entered into a jobs database (not illustrated). If the user determines to search existing jobs at step 302, the user may input and or select search criteria at step 309. For example, the user may select a search criteria such as return all open job positions or return all filled job positions. The user may also enter key words or phrases into a search dialog box to look for positions matching the criteria.

The user executes the search at step 310. The service receives the request and gathers, sorts and returns the search results to the user interface at step 311. The results are displayed for the user at step 312 and represent actionable links to the complete data for the job. If the user determines at step 305 not to search existing jobs, the process may prompt the user to add a new job or jobs to the database. In this case the user may be a supervising entity qualified to add a complete job description including the requirements that must be met for the job.

At step 306 if the user decides not to add a position the process may move back at step 308 to the basic dashboard screen to select a different task. If the user decides to add a job position in step 306, the user may input the job position data into an input dialog box and submit the data to add the job to the jobs database. The process may then move to step 312 where the position or positions added are displayed for review and editing. It is noted herein that a user searching for or adding new jobs to a jobs database may be an enterprise executive charged with filling open job positions including creation of job positions where needed. Duties for such an executive relative to the present invention may also include pairing job candidates with team interview members for job interviews.

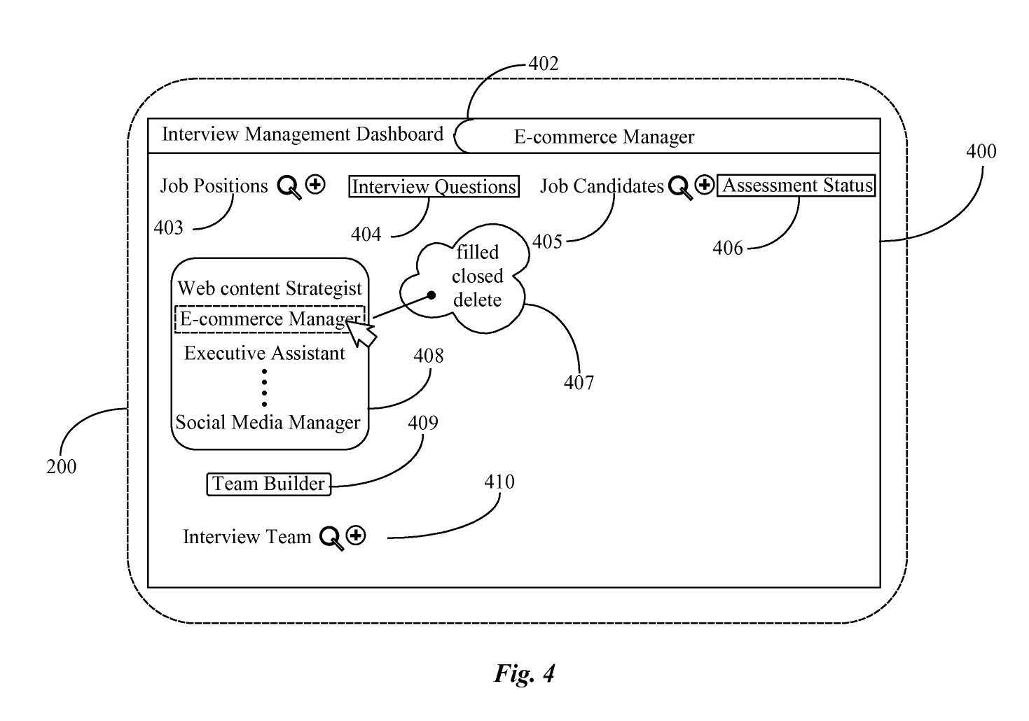

FIG. 4 is an exemplary screen shot of the interview management dashboard depicting selection of a job position for interviewing candidates. Dashboard 200 is illustrated in broken boundary to better depict a dashboard screen 400. Screen 400 has a title bar 402 depicting a selected job as E-Commerce Manager selected from a search result list 408 as indicated by selection arrow and broken boundary around “E-commerce Manager”. When a user computer selects from Open, Closed or Filled Status categories, the user may change the status category of a position, or the user may delete, edit or duplicate a position. When a user computer selects or pauses over a job position from a list of displayed search result entries an information balloon 407 or like message informs the user if the job is filled or otherwise closed and an option for deleting the position from the database may be presented.

Screen 400 is dedicated to E-Commerce Manager, the selected position. The user may select the link Job Positions 403 to conduct another search of the database or to add a new position. Screen 400 includes a link 404 to an interface for displaying skill-centered Interview Questions that may exist for a job position such as for E-Commerce Manager. Such links may point to certain utilities or widgets that are provided to help create skill-based interview questions from basic phrases and antecedents used to form job questions in general. In one embodiment interview questions are directly associated with specific skills that a job position requires a candidate to possess in order to fill the position. More detail about such features is described later in this specification.

Screen 400 includes a link 405 to search for or to add job candidates into the system of the present invention for future interview scheduling. Selecting link 405 enables a search of a database for existing job candidates already entered into the system. Link 405 enables a user to add job candidates into the system database via pop up dialogue box or other computing methods such as copy and paste or voice input.

Screen 400 includes a link 409 for building a team of interviewers. A user may select this link to assign job interviewers to form an interview team having access to the SW and system of the present invention. Job interviewers may be recruited from the host enterprise in one embodiment. There may be a short training period for newly added interviewers, which may include flash courses. Screen 400 includes a link 410 to an existing pool or team of job interviewers having access to the SW and system of the present invention. Interviewers may be added to an existing pool much like adding a new job candidate described above. Link 410 enables a user to browse team interview members. In one embodiment interview members may be graded, rated or categorized, and such criteria may be used to sort search results when a user searches for interview team members.

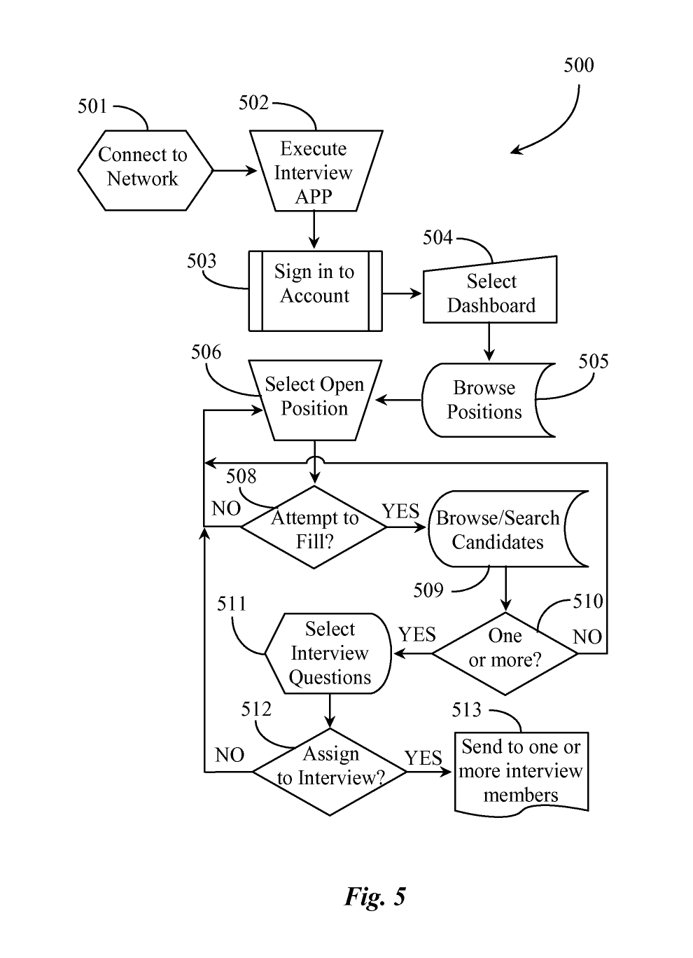

Screen 400 includes a link 406 to an assessment interface to assess how job candidates performed in their interviews with interview team members. The assessment screen contains links to further features that are described later in this specification. FIG. 5 is a process flow chart 500 depicting steps for selecting interview questions and searching for job candidates for a selected position. Assuming a user is not already connected to the network, at step 501 a user operating a network-capable device accesses the network. At step 502 the user executes the interview application either remotely at the server after authentication, or on the user's device hosting the application SW. In this example, the user has the SW installed and executes the SW locally.

At step 503, the user may sign into the user account. In step 504 the user selects the interview dashboard to bring up the first dashboard screen, which may be analogous to screen 400 of FIG. 4. At step 505 the user may browse existing job positions as a prerequisite for setting up a job interview. At step 506 the user selects an open job position from a list of job positions displayed in the dashboard interface. It is noted herein that the user may select a job position from a customized and culled or filtered search list or from a browsed list of all positions in the system. When a user computer selects from Open, Closed or Filled status categories they may change the status category of a position, or they may delete, edit or duplicate a position.

At step 508 the user may determine whether or not to attempt to fill the position selected in step 506. If the user determines not to attempt to fill the position at step 508, then the process may loop back to step 506. If the user determines to fill the selected position at step 508, then the user may select a link to search or add job candidates.

Each job position has association with one or more skills components entered into the system and required of a job candidate in order to fill the job. Each skill component has at least one definition for varying levels of the same skill Interview questions are associated specifically to each skill required for a job position. Questions may be stored in a question bank database and may be served based on what skill and job position are being considered in a pending job interview. An interview assistant interface (not illustrated here) is provided to job interview team members as one tool for use in conducting an interview.

A user may determine for a batch of questions or for question by question whether to assign them to a pending job interview at step 512. If the user determines not to assign one or more questions to a pending job interview at step 512, the process may resolve back to step 506 if the user determines not to create the questions using a question builder interface described later in the specification.

If the user determines at step 512 to assign the one or more questions to a pending job interview for the selected position for which at least one job candidate has been identified for interview, the user may send or transmit the interview questions in order of execution to one or more job interview team members. Part of the process involves paring job candidates with specific team members for interview. One or more than one interviewer may be assigned a single candidate for job interview. One interviewer may be paired with more than one job candidate to be interviewed successively. In one embodiment the questions are entered into an interview component or template that may be displayed on an interview assistant interface accessible to an assigned interview team member.

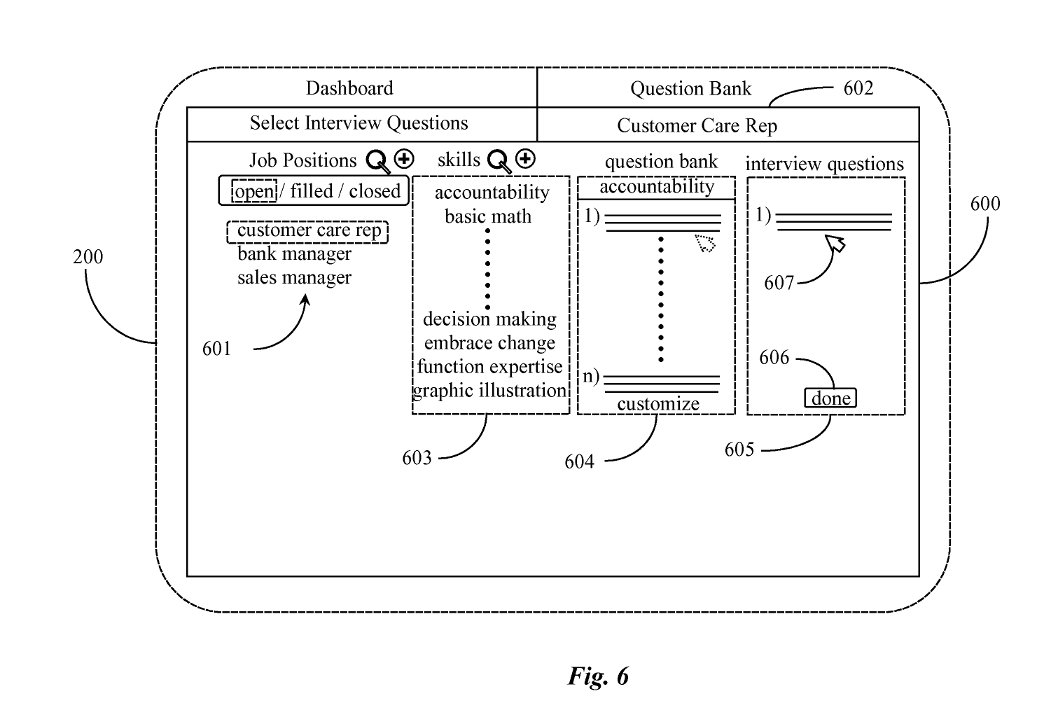

FIG. 6 is an exemplary screen shot of the Interview Management Dashboard depicting selection of skills for a job position and interview questions for a pending interview. In this example, interview dashboard/question bank screen 200 has been accessed and a question bank screen 600 is displayed in the interface. Screen 600 has a title bar 602 depicting accessible functionality for selecting interview questions for an open job position, in this case a customer care representative. Job list 601 depicts the selection of open position customer care rep as indicated by broken boundaries.

All interview questions in the system in one embodiment depend on skills that are associated with a job position. Some skills are specific only to certain jobs while other skills may be considered in most if not all job positions. For example, machining skill may be assigned only to a job that involves metal working while communication skill may be associated with many more job descriptions, but may not be necessary for a metal working position.

A skills list 603 is displayed under a link for searching or adding skills Skills list 603 may be displayed as a result of a skills search or selection of a job position for which skills and questions have already been entered. In one embodiment once the open job position is selected, the skills required to perform the job are automatically displayed in list 603, and may in some instances be edited by the interviewer. In list 603 some skills are general in nature, such as accountability, while others are more specific such as ability to do graphics illustration. In another embodiment a user with authorization may assign specific skills to an open position.

In one embodiment the user may also create one or more new skills and enter them into the skills database. In this example the skills and questions are linked together and applied as linked sets to specific job positions. A user may select the skill Accountability from skills list 603. In this case Accountability list 604 includes Accountability questions 1 through n for consideration of assignment to the pending interview. The user may drag and drop to Interview Questions 605.

Screen 600 includes an interview question list 605. Question list 605 contains all questions that were added to the list from each skill selected. In this example, the user has dropped the first accountability question from list 604 into list 605 representing the list that will be propagated to an interview team member who may be paired with one or more job candidates.

A user may add all or any combination of questions under a specific skill to the final interview question list. A link 604 for customizing questions is provided for a user to select a question and then modify the question to better fit the interview. When a user has added all of the questions to interview list 605 and is satisfied with the result, the user may select link 606 indicating Done or finished adding questions. Clicking Done saves the interview question list into one or multiple formats for distribution to an assigned interview member or members. For example, the list may be formatted as a .pdf file, inserted into a message or email, or reserved to populate an interview assistant interface operated by an interview team member.

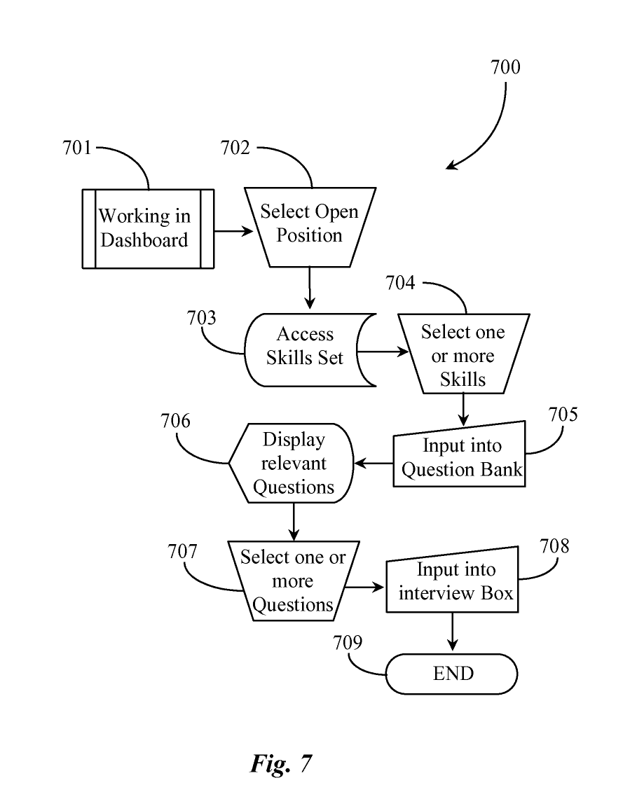

FIG. 7 is a process flow chart 700 depicting steps for selecting skills and accessing relevant questions to add to the interview. At step 701 the user is working in the dashboard interface analogous to screen 600 of FIG. 6. At step 702 the user selects an open job position. Selection of an open job position may automatically result in display of a skills set for that job position where each skill in the skills set is linked to one or more interview questions.

At step 704 the user may select one or more skills and drag and drop one or more of the questions into the interview question area 605. The skill relevant questions may be displayed in list form under each skill added to the list. The user may review through the list to select the questions for the final interview list at step 707. Selected questions are dropped into the interview question box or list space at step 708 to build the interview question list that will be distributed for interviews. The process then ends at step 709.

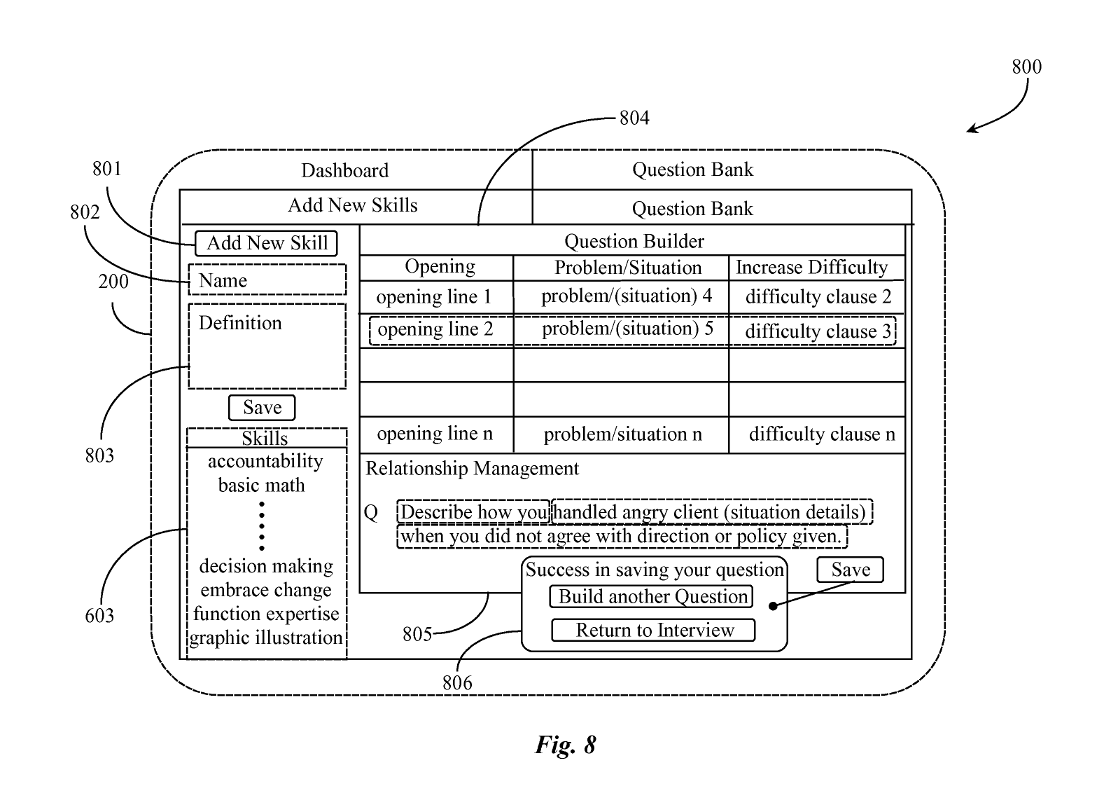

FIG. 8 is an exemplary screen shot of the Interview Management Dashboard depicting addition of new skills for a position and a Question Builder interface for building new questions according to an embodiment of the present invention. In this example interview management dashboard screen 200 is open to a screen 804 for adding new skills to the question bank.

A user may select a link 801 to add one or more new skills into the system. Selecting add new skills link 801 calls up a dialog box 802 for adding the name of the skill and a dialog box 803 for inputting a definition for the skill Each added skill including name and skill definition may be saved by clicking on a save icon after the data is entered.

Skills added through the interface of FIG. 8 may appear in skills list 603. It is noted that saved skills that are new may not yet have any questions associated with them. Screen 800 may include a Question Builder function 805 to aid the user in building questions for new skills the user has added into the system. In one embodiment basic interview questions are partitioned into three parts, these being an opening phrase, problem or issue identification, and a difficulty clause on the end of the question. These components are isolated from one another in a question database and can be mixed or “shuffled” to display potential interview questions.

Interface 805 includes an indication of the skill for which questions are being fabricated, in this case relationship management. Interface 805 may be operated much like a slot machine to achieve random combinations of the parts of the interview questions, namely the opening, problem, and degree of difficulty. Combinations may be initiated each time a user presses a spin icon (not illustrated) or a start option.

Identification of the skill may bear on what question components will be loaded into the question builder. A backend parsing system may disseminate the skill title and definition and then search for question components that match a very similar skill.

In this example there are multiple randomly-generated questions displayed in interface 805. The top line of question builder interface 805 has a question containing opening line 1, problem/situation 4, and degree of difficulty 2. That is to say that the individual parts of a potential question in a same category may vary from one another based on minor differences or according to some rating structure.

In this example the user has selected the second question containing opening line 2, problem (situation) 5, and difficulty clause 3. The resulting question may be displayed at the bottom of the interface under the skill title in an editable mode for the user. The opening line is “describe how you” and the problem line is “handled an angry client (situation details)”, while the last component is the difficulty clause designed to add a specific level of difficulty to overcome. The user may accept situation details that might already be entered into the system in one embodiment by another user who has created questions. In one embodiment the user may add the exact situation details for a problem statement.

Once the user is satisfied with all of the parts of a question, the question may be selected and saved. When a question is saved into the system a pop-up message 806 may appear prompting the user to build another question or to return to the interview management dashboard. In one embodiment questions may be saved in batches. The save questions are organized according to skill in one embodiment. In another embodiment they may be shuffled or otherwise presented in a random order.

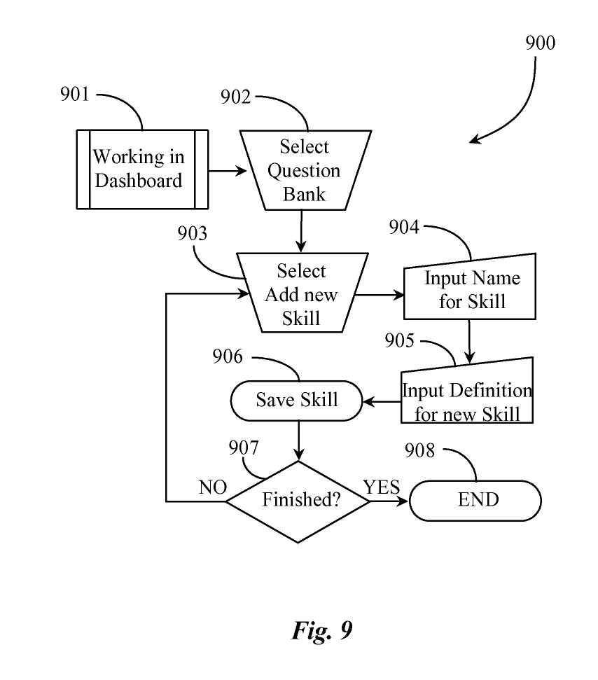

FIG. 9 is a process flow chart 900 depicting steps for adding new skills to a skills database according to an embodiment of the invention. At step 901 the user is assumed to be working in the dashboard interface. At step 902 the user may select Question Bank with the intent of adding a new skill or skills into the Question Bank. In step 903 the user may select a link to add a new skill. This causes one or more dialog boxes to appear for inputting the skill name and a skill definition. The user may input the skill name at step 904 and the definition of the skill at step 905.

When the user is satisfied with the skill name and definition the user may save the skill in step 906. At step 907 the user may determine whether or not they are finished adding skills into the system. If the user is not finished adding skills to the skills database, the process may resolve back to step 903 to add a next skill. If the user is done adding skills in step 907, the process may end at step 908.

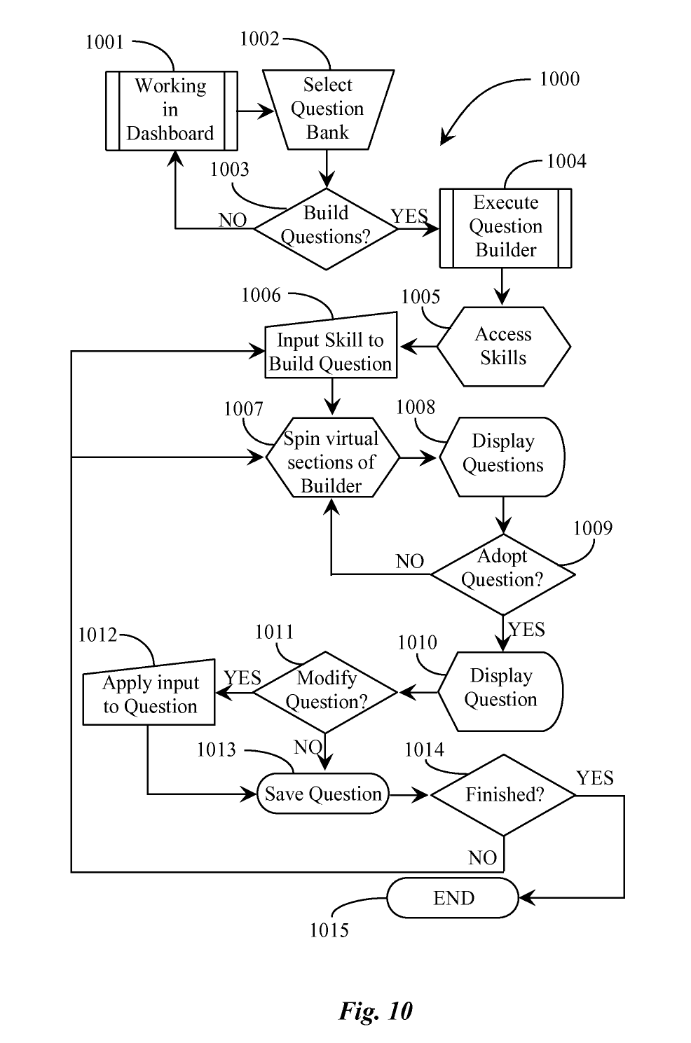

FIG. 10 is a process flow chart 1000 depicting steps for building a question for a job interview skill. At step 1001 the user is connected online and working in the dashboard interface. At step 1002 the user may select the question bank with an intent of building questions for newly added skills. At step 1003 the user makes a determination whether or not to build questions. If the user determines not to build questions at step 1003 the process may resolve back to step 1001. If the user decides to build questions at step 1003 then the user may execute a link to an interface for building questions at step 1004. The Question Builder interface displays for use.

At step 1005 the user may access one or more skills from the list of skills displayed in the dashboard interface. At step 1006 the user may input a skill from the skills list into an input field on the Question Builder screen. The skills are contained in a list displayed in the dashboard as described further above. At step 1007 the user may start or spin the question builder much like a slot machine display to match up the separate question components described further above. The components consist of openers or opening lines, problem/situation description, and difficulty clause. The potential questions are displayed line by line at step 1008 when the virtual wheels on the interface stop moving.

The user may determine at step 1009 whether or not to adopt one or more of the displayed questions for that particular skill. If the user determines not to adopt any of the first-displayed questions at step 1009 the process may return to step 1007 for another spin and random matchup of question components to form the next set of questions. If the user determines to adopt one or more of the generated questions at step 1009 the adopted question or questions are displayed in an editable form in step 1010.

In step 1011 the user may determine whether or not to make modifications to the question or questions including adding specific situation details and modifying language in the individual question components. The user may in one embodiment, have an option of saving modifications for one time use or for general repeated use.

If the user determines not to modify a question at step 1011 the user may save the adopted question into the system at step 1013. If the user determines to modify a question at step 1011 the user may apply input to modify the question at step 1012. The question may then be saved into the system at step 1013. This process may be performed question by question or in batch operation without departing from the spirit and scope of the present invention.

At step 1014 the user determines whether or not he is finished building questions. If the user determines that he is not finished building questions then the process may resolve back to step 1007 for another spin of the Question Builder or back to step 1006 to input another skill for which to build questions. If the user determines to be finished building questions the process may end at step 1015. In one embodiment the skills and questions associated with them are marked as temporary, and may have a time-to-live, such as for one interview, and may not otherwise be saved into the system. In another embodiment the skill-question sets created are saved for reuse in future interview preparations for the same or different job title.

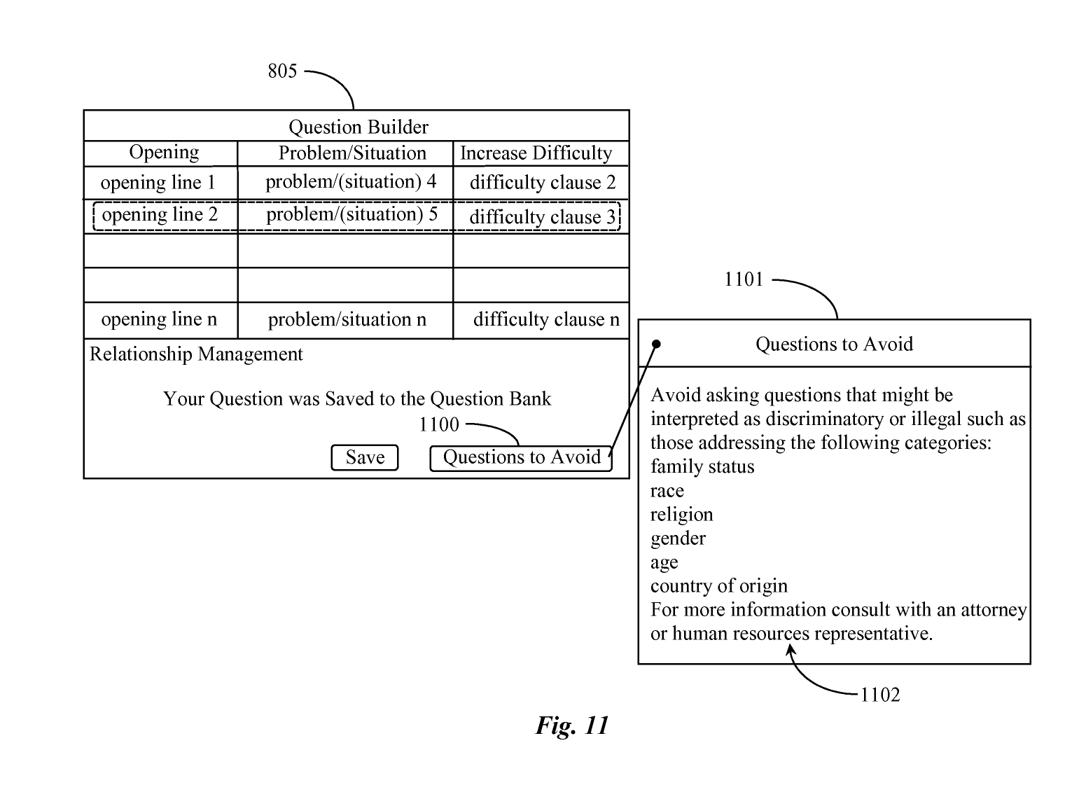

FIG. 11 is an exemplary screen shot of Question Builder interface 805 and recommendations of certain subject areas to avoid when selecting or building new questions. Question Builder interface 805 is depicted un-nested from the browser-based interface to better illustrate detail. At the end of the question building process, a message appears stating the question was saved to the question bank. The question is associated with the skill Relationship Management.

In one embodiment a link 1100 is provided on the question builder interface to a message window 1101 detailing some lines of questioning to avoid including such as family status, race, religion, gender, age, country of origin, etc. In one embodiment new skills that are entered into the system may be evaluated to determine whether there should be more than one level of expertise applied to the new skill. In this case new questions may be built for the new skill levels. In one embodiment when a skill is selected by the user, right-clicking on the selection may reveal the questions associated with the skill. In one embodiment right clicking on a skill may also reveal the skill levels defined, if more than one.

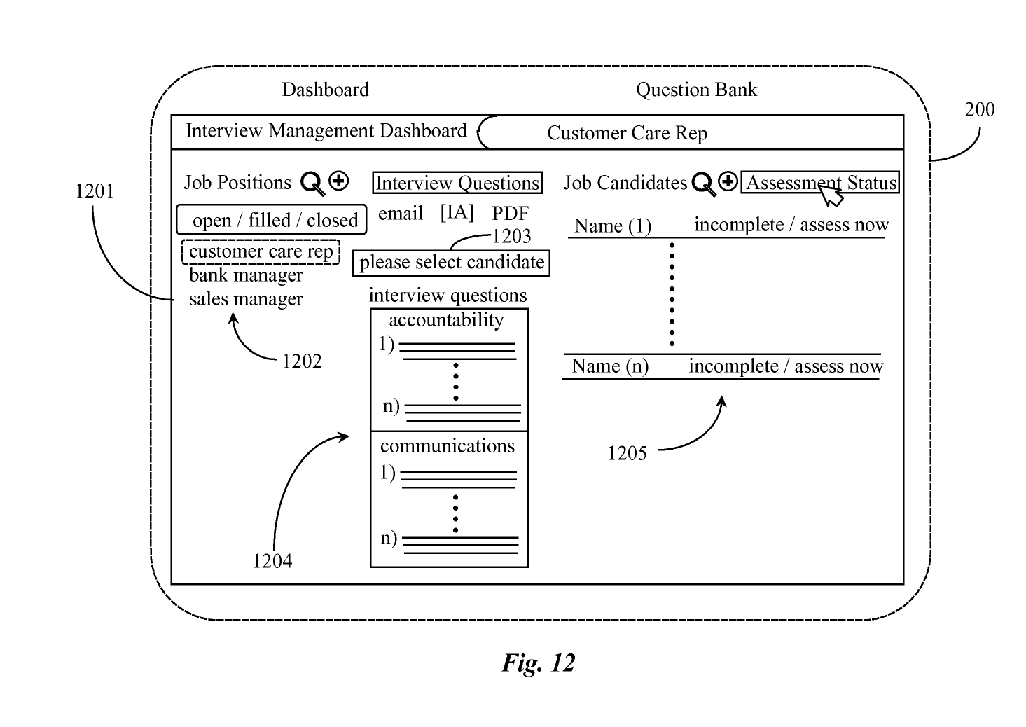

FIG. 12 is an exemplary screen shot of the Interview Management Dashboard depicting gathering of interview question/skill sets for distribution to an interviewer, the distributed data including data about a candidate to be interviewed. In this example Interview Management Dashboard 200 is navigated to a screen 1201 depicting features for gathering skill/question sets for distribution to interview team members and features for assessing the results of an interview for a job candidate.

In this example the job selected from list 1202 is Customer Care Representative. Also in this case the skills and interview questions for the Customer Care Rep position are in the system. A link 1203 is provided to select a candidate or candidates for the job position. Job candidates may be searched or browsed or added by copy and paste. In one embodiment job candidates can be imported from outside through data sources connected to the network. For example, in an enterprise there may be one or more job candidates added from existing internal job holders as well as one or more candidates from outside the enterprise. Skill/question sets for the interview are contained in list 1204. For the skill accountability there are questions 1 through n and for the skill communications there are questions 1 through n.

Job candidates are selected from a list as previously described. Such candidates might be listed in some hierarchical order to reflect their levels of prerequisite skills for the job. The user saves all of the interview questions for the pending interview. Screen 1201 includes a link to assessment status of interviewed job candidates, which when invoked displays assessment status information 1205. A user may select the link to view a list of interviewed candidates and indication of whether the candidates have been assessed relative to their performance in interview. In this example candidates 1 through n are listed with indication of “incomplete” depicting that the candidates (1) and (n) at least have not been assessed. A link to assess now is provided on list entries depicting an incomplete assessment status. All of the candidates listed in information list 1205 have been added to the list with the intention to be interviewed for the open job position Customer Care Representative. However, interview assessment status of job candidates may be more broadly viewed across all current jobs being filled or by department, or by any other sorting criteria.

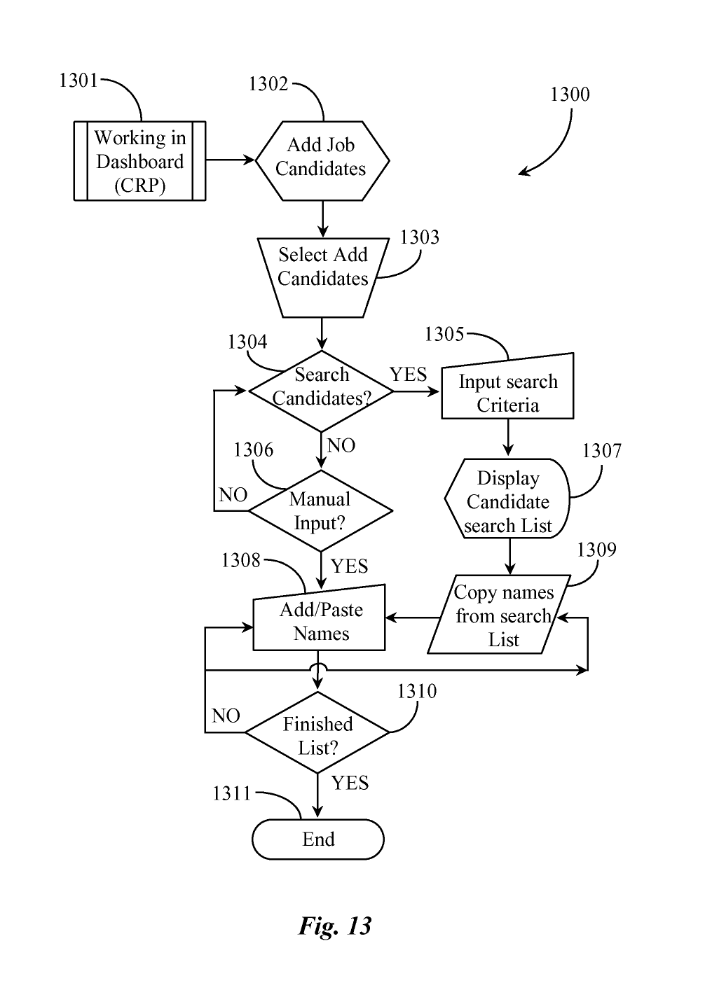

FIG. 13 is a process flow chart 1300 depicting steps for adding job candidates to a position interview event according to an embodiment of the invention. In step 1301, it is assumed that a user is working in the dashboard navigated to Customer Care Rep screen with the intent of preparing an interview for the position Customer Care Rep.

At step 1302, the user prepares to add one or more job candidates to an interview list for the position. At step 1303 the user selects add candidates, which brings up a search/browse interface to discover candidates applying for the position. At step 1304 the user may determine whether or not to search an existing database for candidates. It is noted that a search may access more than one database to discover job applicants that may be candidates for the job position the user is attempting to fill.

If the user determines to search candidates at step 1304 the user may input search criteria into a search dialog box associated with the search function. An example might be all applicants that returned an application for Customer Care Rep. In a recruiting situation a job candidate that may have applied for a similar job but not the exact job may be considered for interview and may be offered an opportunity to interview for the position even though the applicant applied for a different position, which may be already filled or otherwise not now available to the applicant. In this way potential talent in a talent pool may be better cultivated to fill job positions with the most qualified individuals.

In case of recruitment, an applicant may be contacted by the system and informed about the unavailability of the job the applicant recently applied for but that he or she may be qualified for the open customer care rep position. The applicant may give permission to be included in the interview pool and may consent to fill out a quick online application for the actual position before interview. The overall assessment view of the skills of job candidates may be cross referenced across multiple job positions of highly variant descriptions and requirements. Therefore, candidates possessing certain skill levels that may not be enough for a position they applied for may be referred to other positions in the system based on their interview assessment and skill matching in the jobs database.

In step 1307 the Candidate Search List is returned to the interface. In one embodiment all of the candidates on the list have applied for the position being staged for interview. In another embodiment the list is put together based on an understanding of skills the job candidates actually possess as assessed from one or more previous interviews wherein the interview is an offer to an applicant who actually applied for one or more other positions but was not hired for the position.

At step 1309 the user may select, mark, or copy candidate names from the returned list of candidates and may paste them or otherwise enter them into a pending interview template for one or more interview team members at step 1308. If at step 1304 the user decides not to search existing candidates, the process may move to step 1306 where the user may determine whether or not to manually input candidate data into the template from any source.

If the user determines to manually add candidate data at step 1306 the user may add the data into a dialog box on the template. A combination of the methods may also be undertaken such as copying one or more candidates from an existing list of applicants and adding more candidate data from one or more other sources of information accessible to the user staging the interview for customer care representative.

At step 1310 the user may decide whether or not the candidate list for an interview is finished. If the user determines that the candidate list is not yet finished in step 1310, the process may resolve to step 1308 or to step 1309 until all of the candidate data has been added. It is noted herein that interview templates might be prepared individually for different interview team members interviewing candidates for a same job. Candidates assigned to those interview team members would appear on the candidate list for that interview team member. In one embodiment the interview template contains all of the interview team members that will be conducting interviews for the position and all of the job candidates that will be interviewed. The interview team may then discuss and settle which candidates will be interviewed by which interviewers.

In one embodiment interviews are scheduled by a system or agent that is not an interviewer and interview events are created and disbursed to interview team members with notifications disbursed to the candidates. The notifications include the date and time of the interview and how it will be conducted, for example, telephone interview, live interview, etc. If the user determines the candidate list is finished at step 1310, the process may end at step 1311.

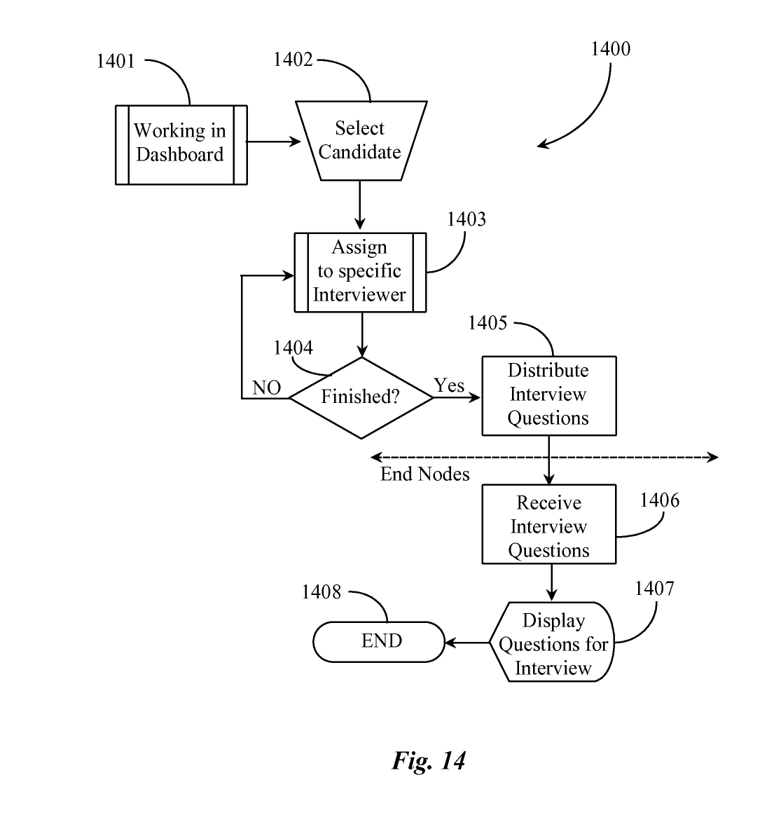

FIG. 14 is a process flow chart 1400 depicting steps for assigning a job candidate to an interviewer and transferring data to the interviewer before the interview date. It is assumed in this example that the user is working in the dashboard with the intent of selecting job candidates for interview team members. In step 1402 the user may select a candidate from a list of candidates created for the position interview. It is important to note herein that there may be multiple candidates interviewed for one job position.

At step 1403, the user may assign the candidate to a specific member of the interview team that will be conducting the interview. Steps 1402 and 1403 may be repeated for all of the candidates on the list until the user determines in step 1404 that the assignment process is finished for all of the listed candidates. In one embodiment an interview team member may be assigned multiple candidates and multiple interview dates. In another embodiment there may be more than one interviewer per candidate. Assignment particulars may vary widely depending on the number of candidates, the number of available interviewers, the interview structure, etc.

If the user determines that the assignment process is not finished in step 1404, the process may resolve back to step 1403 until the user is done. If the user determines that the assignments of candidates to interview team members is complete, the process moves to step 1405 where the user may distribute interview questions to the interview team members to conduct the interviews.

In one embodiment the interview questions are distributed to the interviewers with indication of the candidates and interview schedule including method, place, date, and time. Interview questions might be distributed through email or in a .pdf or Word™ document, for example. Interview questions may also be included in a message or post. In one embodiment the interview questions are served from a server when an interviewer executes an Interview Assistant before the start time of a pending interview. The Interview Assistant may be nested in a browser interface or it may be a standalone application on a mobile phone or other network capable device.

At step 1406, the interview team members receive interview questions and other data relative to the interview, such as the type of interview, the date, time and candidate identification and contact information. In one embodiment the interview is scheduled when the interview team members receive their interview questions. In another embodiment the interview team members are charged with contacting the candidates and scheduling the interviews themselves after receiving the interview questions and candidate data. The interview team member may display the interview questions at the time of the interview at step 1407. At step 1408 the process may end.

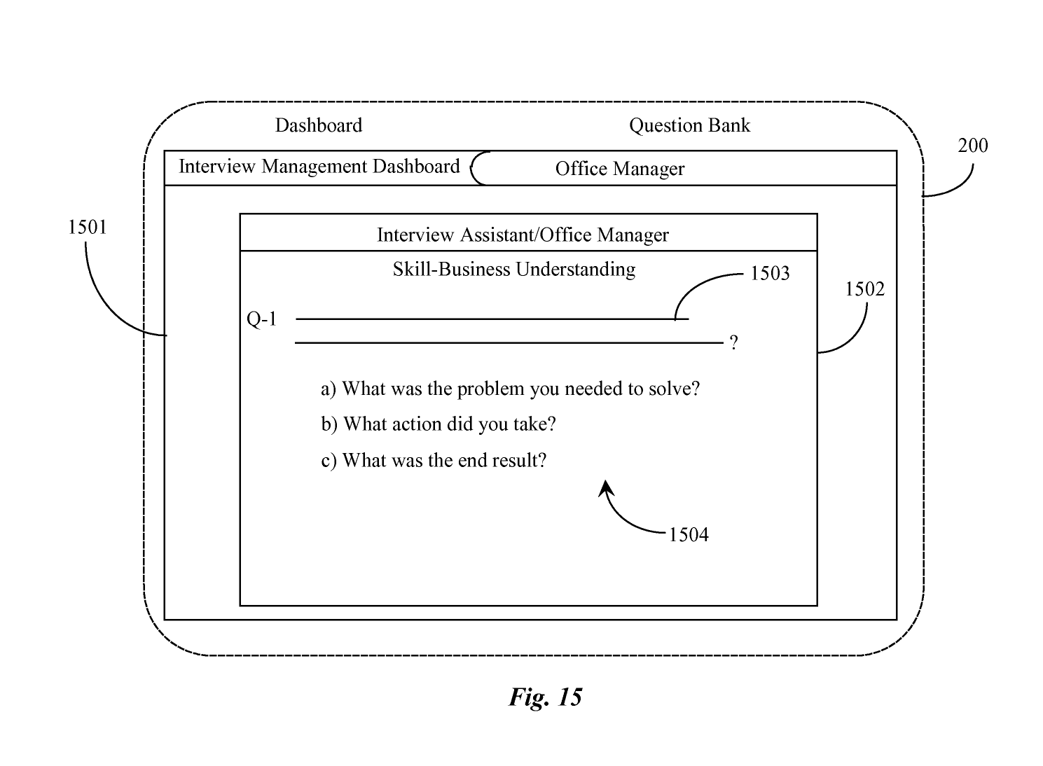

FIG. 15 is an exemplary screen shot of the Interview Management Dashboard displaying an Interview Assistant for an interview team member. In this example, Interview Management Dashboard 200 hosts an Interview Assistant interface 1502. Interface 1502 includes one or more interview questions 1503 that have been loaded into the interface. In this example the Interview Assistant is for the open job position of Office Manager. Question Q-1 is a first interview question relative to a required and identified skill Business Understanding. The title bar on the assistant depicts the job position Office Manager, which is the position for which the questions were sorted. Each skill identified may have one or more questions associated with it.

Although not illustrated in this example, the Interview Assistant may include data such as identification and contact information for candidates associated to the team member or members receiving the interview questions. Information may also include interview date and time and method for the interview, for example, in person or telephone, etc. In one embodiment the interview is already scheduled through a separate mechanism such as a calendar application, and the interview questions are made available just before the interview time occurs.

In one embodiment each interview question is followed by one or more qualifying questions 1504. The interview team member may ask or just view the questions while evaluating the answer to the question asked of the candidate. The qualifying questions are termed Problem Action Result (PAR) questions by the inventor. The qualifying questions are designed to help assess the sincerity of the candidate's answers to the main interview questions. Interface 1502 may include a scroll bar and links to other resources that might be accessed during an interview.

In one embodiment an Interview Assistant may be shared by more than one interview team member interviewing a single job candidate. In this case the interface may contain presence information that indicates to a second interviewer that the first interviewer is busy in the first stage of the interview wherein notification is given when the candidate becomes available to the second interviewer. Assessment may occur between successive interviews of the same candidate by two or more interviewers. In one embodiment a second interviewer may access the interview answers given in the first interview before deciding to conduct the second interview, especially if access to the second interview depends on passing the first interview with satisfactory assessment.

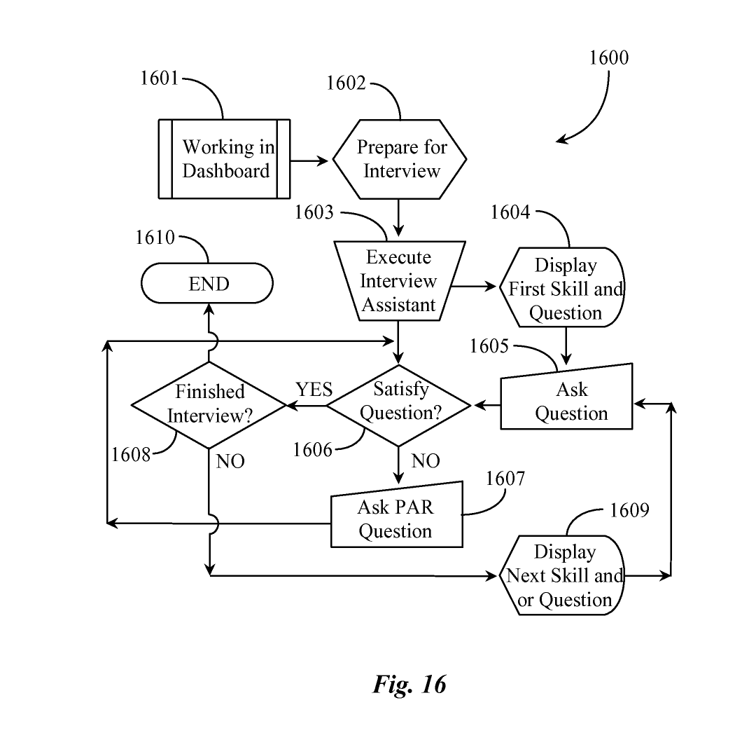

FIG. 16 is a process flow chart 1600 for conducting an interview according to an embodiment of the present invention. In this example, it is assumed that the user is working in the dashboard at step 1601 with the intent of preparing for an interview at step 1602. For example, a candidate may be present and ready for the interview. At step 1603 the interview team member may execute the Interview Assistant. In this case, the questions are loaded into the Interview Assistant for the current interview.

At step 1604 the interviewer displays the first skill and question of the interview. It is noted herein that the questions may also be provided through another mechanism, such as a document or message body. In one embodiment the Interview Interface may be in the form of an audio interface such as a voice whisper on a telephone headset for a telephone interview wherein the interviewer may first hear the question on whisper transparent from the candidate connected by telephone.

At step 1605 the interviewer may start the interview by asking the first interview question. At step 1606 the interview team member may determine whether the candidates answer to the first question is satisfactory to the interviewer. If the interviewer determines that the answer is satisfactory at step 1606 the process may move to step 1608 where the interviewer makes a determination of whether the interview process is finished. If the interviewer determines at step 1606 that the candidate's answer is not satisfactory, the process may move to step 1607, where the interviewer may ask a Problem Action Result (PAR) question. The process may loop back to step 1606 for each PAR question asked until the interviewer is satisfied with the candidate's answer.

If the interview team member is satisfied with the initial answer to the first interview question asked, the process moves to step 1608 where the interviewer determines if the interview is finished. If the interviewer determines at step 1608 that the interview is not finished the interviewer may display the next skill and question or the next question under that same skill, and may ask the next question at step 1605.

The process may be repeated for as many questions as there are loaded in the interface for the interview. If the interviewer determines the interview is finished in step 1608 the process may end at step 1610. In one embodiment each question includes a comment dialog box for the interviewer to enter comments or notes reflecting the interviewer's pre-assessment comments or suggestions, or questions.

It is important to note herein that an Interview Assistant may be used for one stage of an interview and then saved for disbursement to a next interviewer for conducting a next stage of an interview with new questions loaded into the interface that may be selected based in part on assessment of the first stage of the interview process with the candidate. That is, new questions might be automatically or manually created that are based at least partly on an identified skill and information disclosed by the candidate at the first stage of the interview. In one embodiment candidate answers are documented (recorded) from voice, text, or through notation during the interview without departing from the spirit and scope of the invention.

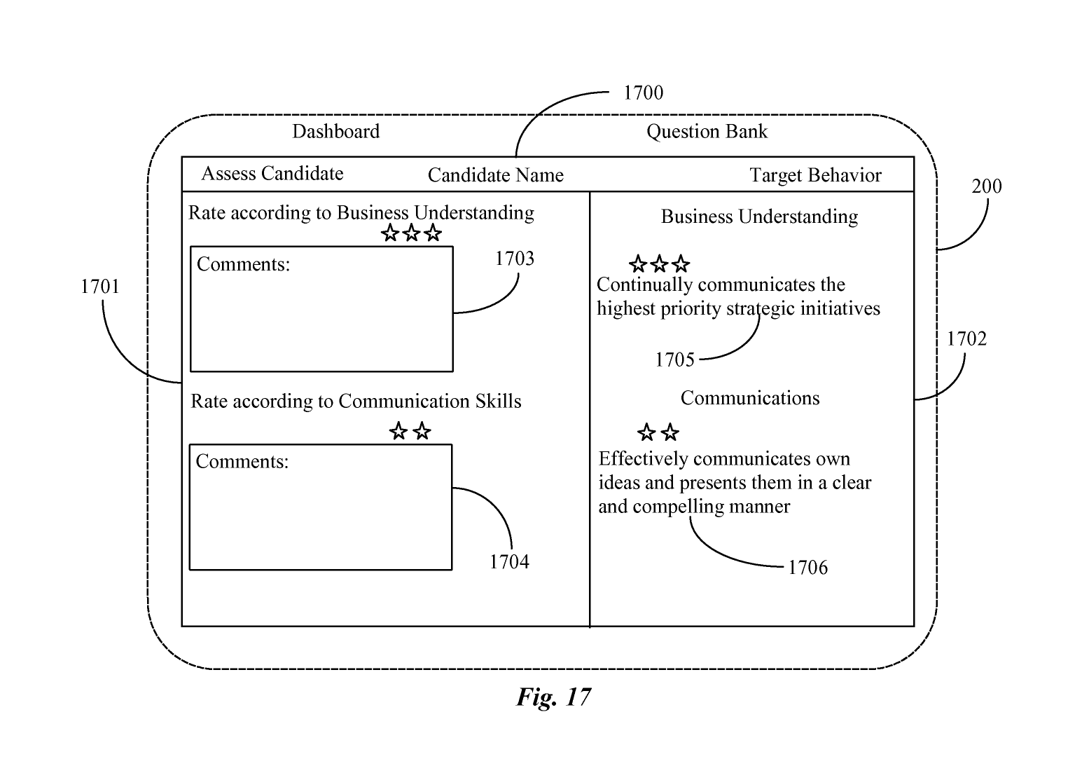

FIG. 17 is an exemplary screen shot of an interview assessment interface 1701 according to an embodiment of the invention. In this example interview management dashboard 200 hosts an interview assessment interface 1701. Interview assessment interface 1701 may be spawned automatically at the conclusion of an interview or of one stage of an interview process.

Interface 1701 includes a title bar containing the title of the interface (Assess Candidate) the candidate name and target behavior during the interview as assessed by the interviewer or some other user charged with assessing job candidate performance during the interview process.

Any user assessing a job candidate after the interview process may have access to the original interview questions and job description including requirements, the identification and contact information of the candidate, the candidate's answers if recorded, and any other data resource that may help in making the assessment.

In one embodiment the interviewer may assess a candidate's performance immediately after an interview. In another embodiment assessment is performed by a third party, and may be done at a later time. In this example a star rating scheme is utilized to rate the candidate's performance. The assessment routine may generally follow each skill the candidate has answered questions about during the interview. In this screen the first skill is business understanding. The assessor is asked to rate the candidate's mastery of the skill of business understanding based at least in part on the answers given to questions under that particular skill. Screen 1701 includes a comment dialog box 1703 associated with the displayed skill Business Understanding. In this example the assessor, which may be the interviewer, has given the candidate a three star rating out of four stars. Each star corresponds to a particular level of mastery of the overall skill Business Understanding. Each star level is associated with a boilerplate system level of mastery of the skill. A notification screen 1702 is provided embedded or otherwise linked to screen 1701. Notification screen 1702 displays system notification based on how many stars are used to rate the candidate for a skill.

In this example the interviewer is making the assessment and has given the candidate three stars for the skill of Business Understanding. For this skill at three stars, the system returns a message 1705 stating the definition of the three star level for Business Understanding. The message 1705 reads candidate “continually communicates the highest priority for strategic initiatives”.

The next skill to be rated is Communication Skills. The interviewer has allotted two stars to the candidate in this skill category. A comment dialog box 1704 is provided to accept any assessor input or feedback. Upon indication to the system of the two star rating a message 1706 is returned to screen 1702 that indicates the candidate effectively communicates own ideas and presents them in a clear and compelling manner.

The process continues skill by skill for all of the skills listed in the job description. It is noted herein that the job title, job definition, candidate name, interviewer name as well as other information may be available in the assessment interface. In one embodiment a question review link may be provided in assessment interface 1701 that may cause display upon invocation, of the original questions asked and the answers given as well as notes made during the interaction.

In one embodiment the assessor is the interviewer and through the interview process has come to understand the candidate's skill levels for each skill required by the job position. When a message such as message 1706 appears, the interviewer/assessor may determine if the system message returned for a star rating given is accurate enough to forgo modification.

In one embodiment an assessor may gauge how accurate a system message is in light of the rating originally given. If the assessor feels that the system message is not entirely accurate he or she may elect to edit or adjust the rating by adding or subtracting a star. In one embodiment the star system may incorporate half-star rating. Any rating scheme may be used to rate candidate performance in a job interview. Star rating is, of course, just one example of a rating quantification. Many other sorts of quantification may be used, such as numbers from 0 to 10 or 100, or percentages, for example.

In one embodiment of the invention all of the job skills required in job description may be individually rated and the overall performance rating for the interview is an average of the individual skill ratings. It is important to note that external or static data not part of the actual interview may be used in some embodiments as a weight factor to apply against an overall interview performance assessment rating without departing from the spirit and scope of the present invention.

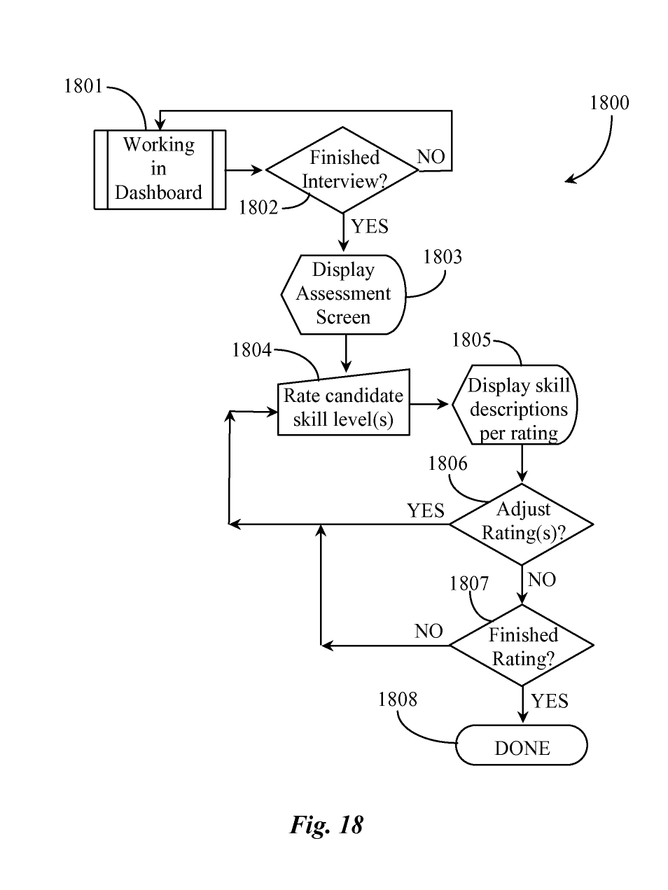

FIG. 18 is a process flow chart 1800 depicting steps for rating a candidate's skill levels after an interview according to an embodiment of the present invention. It is assumed in this example that an interviewer is working within the dashboard and Interview Assistant at step 1801. At step 1802 the interviewer determines if the interview has concluded. If the interview has not concluded at step 1802 the process loops back to the interview.

If the interview is determined to be finished at step 1802 the interviewer may indicate that by submitting the interview record to cause display of an assessment screen at step 1803 for rating a candidate's mastery of each of the skills required by the job position involved. The assessment screen may contain all of the required links to various parts of the interview such as the questions, interviewer comments, and candidate answers if recorded.

The assessor begins rating the candidate skill level mastery for each skill at step 1804. For each skill the assessor selects a rating level of more than one available level. In one embodiment a four-star system is used but the rating structure may vary widely such as from 1 to 5, percent of 100%, ABCD, etc. Each identified rating level is known to the system for the skill involved. At step 1805 the system learns the rating level applied by the interviewer/assessor for a skill and returns a boilerplate description of that level for the assessor to review.

The assessor may determine at step 1806 whether to adjust the rating from the original submitted rating. This may be accomplished by adding or subtracting a star (four star rating system) in the event that the returned rating description accurately reflects the view of the assessor of the candidate's mastery of the involved skill. If the assessor determines not to adjust the rating at step 1806, the assessor may determine at step 1807 whether rating is completed for all of the skills included. If the assessor is finished rating then the process may end at step 1808.

If the assessor determines at step 1806 to adjust a rating, the process loops back to step 1804 where the assessor may change a rating value. The process loop involving step 1804, 1805, 1806, and 1807 may be repeated for each skill included in the assessment interface until all of the skills have been rated satisfactorily. The system may calculate an average rating for the candidate across all of the skills identified in the interview reflecting the overall performance value of the candidate for that position.

In one embodiment of the present invention a final rating procedure may be provided to rate the match factor between a candidate and a job position over all of the skills involved.

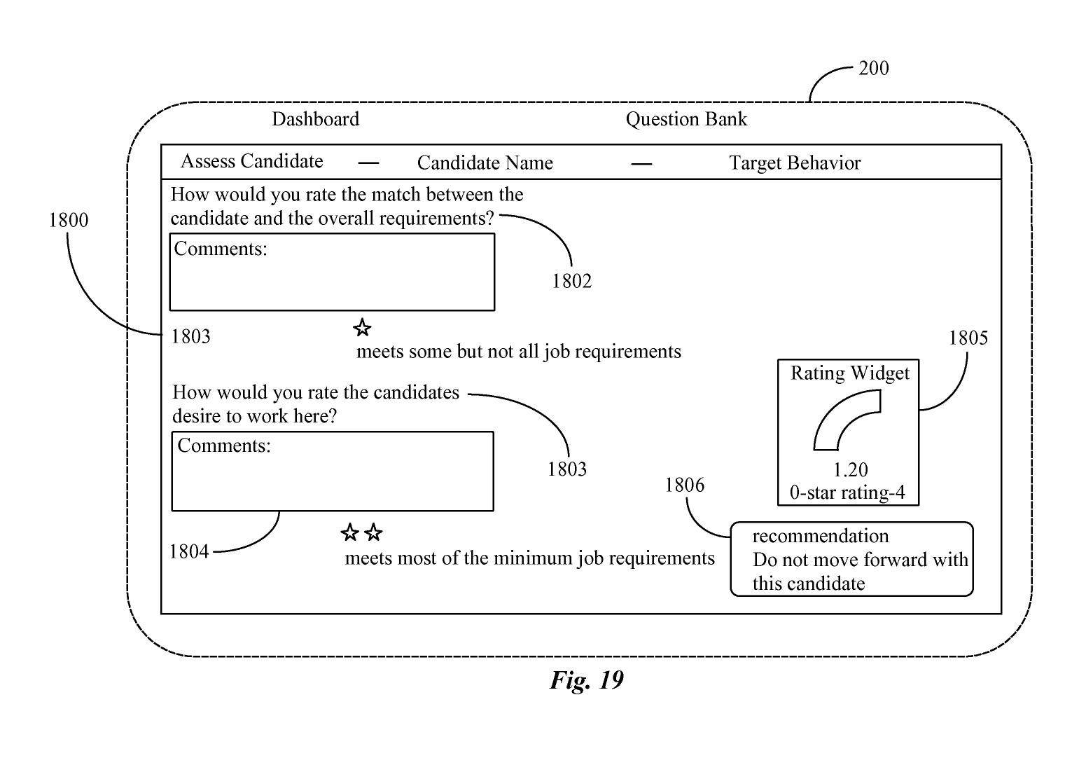

FIG. 19 is an exemplary screen shot of the interview assessment interface 1800 depicting a utility for final rating of a candidate according to an embodiment of the invention. In this example, dashboard 200 is hosting the assessment screen 1800. Screen 1800 may be analogous to screen 1701 of FIG. 17 with the exception of a rating widget 1805 provided to display average overall rating. In one embodiment a color code may also be used to portray certain rating levels such as yellow to red, with yellow being the low end and red being the high end. There are many possibilities.

In one embodiment after all of the skills are rated for a candidate relative to a job position the assessor may be asked to answer a set of final questions about the interviewed candidate's match potential to the required skills of the job position. A first question may be question 1802 “How would you rate the match between the job candidate and the overall job requirements”. A comment dialog box is provided for the assessor to enter comments additional to a rating. In this example the assessor gave one star rating for the first question. The system recognizes the rating and provides a return message defining the match rating “meets some but not all job requirements”.

The next question asks how the assessor would rate the candidate's overall desire to work at the enterprise. This question has nothing to do with skill but may address a level of enthusiasm of the candidate. The assessor provides a two star rating as an answer to the question. Comments or feedback may be entered into dialog box 1804. The two star rating returns a message “meets most of the minimum job requirements”. There may be five or more questions asked during this rating process although only two questions are illustrated here.

Screen 1800 includes a rating widget 1805 that displays the candidate's overall rating in a four star rating system. This includes the prior rating values relative to the separate skills and any new values added in the final rating process described in this example. Widget 1805 may have different graphical views such as a bar or graph or text without departing from the spirit and scope of the invention. A system message may be displayed in association with widget 1806 that may be a system recommendation based upon the system calculation of the overall rating value for the candidate after all rating is finished. In this case the message 1806 reads “Do not move forward with this candidate.” It needs to be mentioned that the average rating for all of the skills is subject to modification when the final rating values are applied.

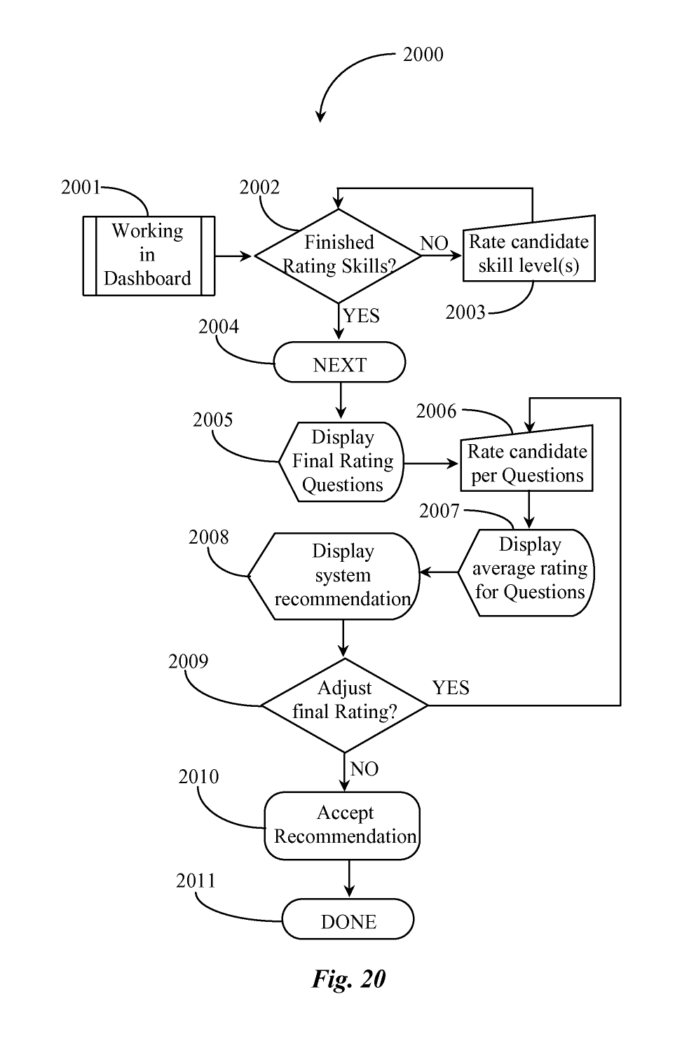

FIG. 20 is a process flow chart 2000 depicting steps for final rating of a job candidate according to an embodiment of the invention. It is assumed in this example that the assessor is the job interview team member working within the dashboard application at step 2001. The assessor may make a determination at step 2002 whether the skills rating process is finished for the candidate. The skills rating process produces an overall rating for the candidate based on the candidate's ability to perform at the position.

If the assessor determines that the skills rating process is not complete the process moves to step 2003 to continue rating candidate skills and then loops back to decision step 2002. If the assessor determines at step 2002 that the skills rating process is completed for the candidate, the assessor may select a next button in the assessment interface at step 2004 to execute the final rating process.

At step 2005 the system may display the final rating questions in the assessment interface. In one embodiment the assessment interface screen may be hosted within the Interview Assistant interface described above. At step 2006 the assessor begins to manually rate the candidate according to the final rating questions. At each question a rating is performed. The rating system may be a four star rating system for example. There may be five final questions for an example, but there also may be fewer questions or more questions displayed without departing from the spirit and scope of the invention.

In one embodiment step 2006 occurs for all of the final questions before step 2007. At step 2007 the system may display the average rating for all of the rated questions. In one embodiment the average rating displayed may include the overall rating of the candidate according to the skills of the job position. At step 2008 the system may display any system recommendations tied to the rating value such as it is recommended to move forward with this candidate or it is recommended to re-interview this candidate in one or more of the original skill areas.

The assessor may have an opportunity at step 2009 to determine whether or not to adjust the final rating according to any of the final questions by adjusting the individual ratings of any of the final assessment questions. This may involve adding or subtracting stars in a star-based system. If the assessor determines at step 2009 to adjust the final rating, the process may move back to step 2006 where the assessor may review and adjust any of the original ratings of the final assessment questions. In one embodiment the interviewer may be authorized to directly adjust the overall rating value, which would reversely affect the original ratings by equal amounts.

If the assessor determines not to adjust the final rating average at step 2009 then the assessor may accept the system recommendation and close the interview process for that candidate at step 2010. The process may then end at step 2011 for that job candidate. In one embodiment the final rating average can only be adjusted by changing the rating values of any of the final assessment questions. In one embodiment the interview management system can be practiced over a server network using Web Services Description Language (WSDL) or other suitable language for Web interfaces. The system may also be practiced over a voice telephony network without departing from the spirit and scope of the invention, for example, the interview assistant and assessment interface may be audio interfaces. In one embodiment interview team members may also perform interviews in the field, such as at a candidate's current location outside of the enterprise providing the job opening.

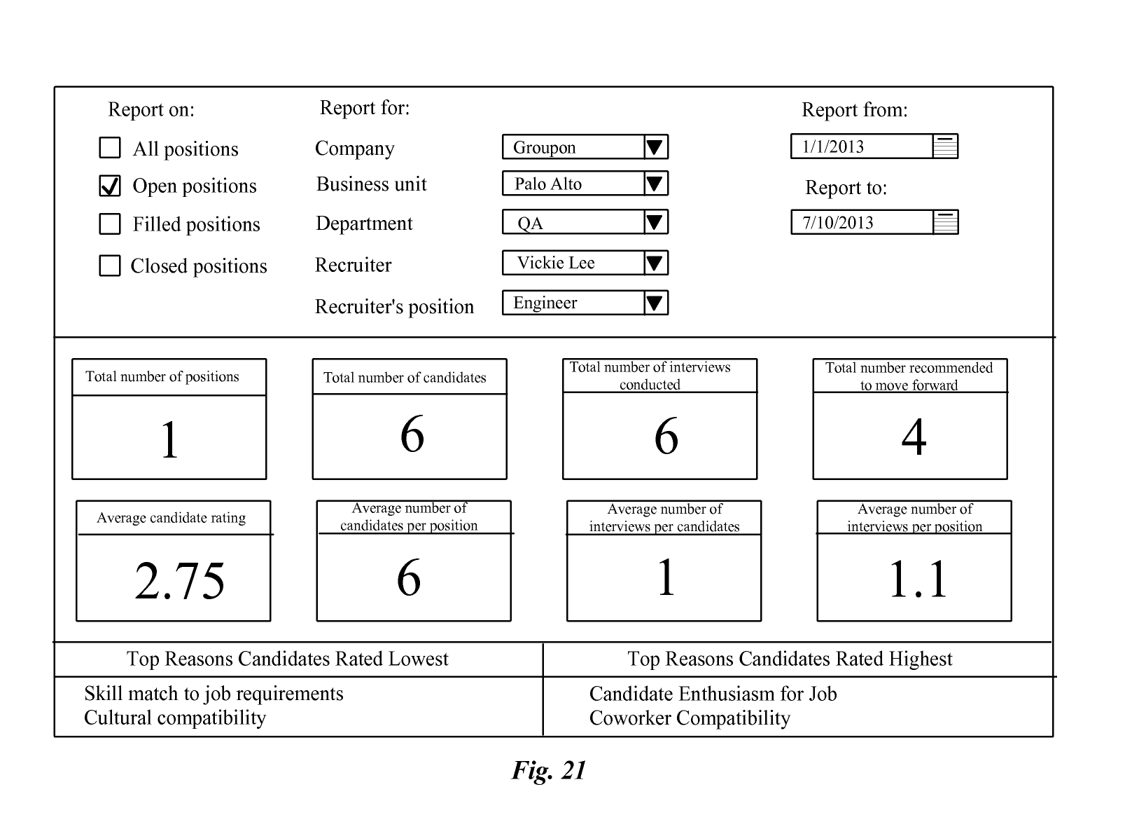

FIG. 21 is an exemplary interactive screen illustrating a statistical analysis and reporting function provided in an embodiment of the invention. In operation of the invention all activities are tracked and recorded, such as job listed to be filled, job descriptions, skills entered as required for qualifying for a job, questions associated with skills, applicants entered to try to qualify for jobs, interviews actually conducted, assessment of candidates, and all results. FIG. 21 provides selection of type of report, whom the report is for, and a time window. With the selections made, the system accesses the stored information and populates the output boxes. In addition the system in this embodiment may also provide the top reasons candidates rated lowest and highest. This information is found to be useful for fine tuning and planning.

It will be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A system comprising:
a network-connected server;
a physical computer processor operating in the network-connected server;
a data repository coupled to the network-connected server;
a first computerized appliance connected to the network and operable by a user acting as an interviewer;
coded instructions executing on the physical processor;
information regarding a job to be filled stored in the data repository, the information comprising skills required for the job and one or more questions associated with each skill required for the job; and
information regarding a candidate for the job to be filled stored in the data repository;
wherein the coded instructions provide for distributing the one or more questions associated with each skill to the user acting as the interviewer, enabling the user to ask the questions of the candidate present with the interviewer and to record or evaluate the candidate's responses.

2. The system of claim 1 wherein the coded instructions provide an interactive Interviewer Dashboard on a display of the computerized appliance, the Interviewer Dashboard providing one or more interactive interfaces enabling the interviewer to access the information regarding the job to be filled and the candidate for the job, to access the preprogrammed questions for each skill, to ask the questions of the candidate present with the interviewer and to record or evaluate the candidate's responses.

3. The system of claim 1 wherein the candidate responses to questions are audio recorded or manually recorded by the interviewer, and the recordings are stored in the data repository associated with the candidate information for later recall and analysis.

4. The system of claim 1 wherein the interviewer is enabled to enter comments and opinions that are associated with individual ones of the skills and stored along with the candidate's responses for later retrieval and analysis.

5. The system of claim 1 wherein there are multiple jobs to be filled with information stored in the data repository, one or more candidates for each job to be filled, skills associated with each job, and preprogrammed questions associated with each skill, and wherein the Interviewer dashboard enables the interviewer to select jobs, candidates and questions to perform interviews for individual ones of the jobs to be filled with individual ones of the candidates for each of the jobs.

6. The system of claim 1 further comprising a second computerized appliance connected to the network and operable by the candidate for the job, and wherein the candidate for the job connects to the network-connected server and is provided with a Candidate Interface, and the interviewer is enabled to question the candidate remotely, with the candidate's responses recorded in the data repository for later retrieval and analysis.

7. The system of claim 5 wherein the coded instructions enable entry of new jobs to be filled with job descriptions, new skill sets associated with the jobs to be filled, and new question sets associated with the skill sets.

8. The system of claim 5 wherein the interviewer is enabled to edit skills and question sets after selecting a job to be filled and a candidate for the job, and before or during the interview with the candidate.

9. The system of claim 7 comprising a Question Builder function wherein interview questions are created having three parts, a first part being an opening phrase, a second part being a problem or issue, and a third part being a difficulty clause, and wherein the parts of questions may be randomly shuffled to create new questions.

10. The system of claim 1 wherein the Interviewer Dashboard enables the interviewer to retrieve stored candidate responses associated information, and to select a best candidate for the job to be filled.

11. A method comprising:
presenting an interactive interface for a user acting as an interviewer on a display of a computerized appliance connected on a network to a network-connected server executing coded instructions on a physical computer processor;
distributing to the user acting as an interviewer questions stored in a data repository coupled to the server, the questions specifically associated with skills required for a job to be filled;
asking by the user acting as an interviewer of a candidate for the job to be filled, the candidate present with the interviewer, the questions associated with each skill;
recording or evaluating the candidate's responses to each question for later analysis; and
recording the interviewer's assessment of the candidate.

12. The method of claim 11 wherein the user acting as an interviewer is presented with an interactive Interviewer Dashboard enabling the user to access information regarding the job to be filled, the candidate for the job, information comprising the skills required for the job and the questions associated with each skill directly from the data repository.

13. The method of claim 12 wherein the candidate's responses to questions are audio recorded or manually recorded by the interviewer, and the recordings are stored in the data repository associated with the candidate information for later recall and analysis.

14. The method of claim 11 wherein the interviewer is enabled to enter comments and opinions that are associated with individual ones of the skills and stored along with the candidate's responses for later retrieval and analysis.

15. The method of claim 11 wherein there are multiple jobs to be filled with information stored in the data repository, one or more candidates for each job to be filled, skills associated with each job, and preprogrammed questions associated with each skill, and wherein the Interviewer dashboard enables the interviewer to select jobs, candidates and questions to perform interviews for individual ones of the jobs to be filled with individual ones of the candidates for each of the jobs.

16. The method of claim 12 further comprising a second computerized appliance connected to the network and operable by the candidate for the job, and wherein the candidate for the job connects to the network-connected server and is provided with a Candidate Interface, and the interviewer is enabled to question the candidate remotely, with the candidate's responses recorded in the data repository for later retrieval and analysis.

17. The method of claim 15 wherein the coded instructions enable entry of new jobs to be filled with job descriptions, new skill sets associated with the jobs to be filled, and new question sets associated with the skill sets.

18. The method of claim 15 wherein the interviewer is enabled to edit skills and question sets after selecting a job to be filled and a candidate for the job, and before or during the interview with the candidate.

19. The method of claim 17 comprising a Question Builder function wherein interview questions are created having three parts, a first part being an opening phrase, a second part being a problem or issue, and a third part being a difficulty clause, and wherein the parts of questions may be randomly shuffled to create new questions.

20. The method of claim 11 wherein the Interviewer Dashboard enables the interviewer to retrieve stored candidate responses associated information, and to select a best candidate for the job to be filled.

21. The method of claim 11 wherein the interactive Interviewer Dashboard enables the interviewer to assess the candidate's likelihood for success in the position, for storage in the data repository.

22. The method of claim 11 wherein the interactive Interviewer Dashboard enables a report function providing reports and summaries of interviewing data to be used in analysis of the interviewing process.
